(19) United States
(12) Patent Application Publication
(10) Pub. No.: US 2003/0203075 A1
(43) Pub. Date: Oct. 30, 2003

(54) Flavored straw inserts

(76) Inventor: Lee Richard Taylor, Brussels (BE)

Correspondence Address: SUTHERLAND ASBILL & BRENNAN LLP, 999 PEACHTREE STREET, N.E., ATLANTA, GA, 30309, US

(21) Appl. No.: 10/384,123

(22) Filed: Mar. 7, 2003

Related U.S. Application Data
(60) Provisional application No. 60/375,581, filed on Apr. 25, 2002.

(51) Int. Cl. A23L 1/00

(52) U.S. Cl. 426/85

(57) ABSTRACT

An insert for use with a drinking conduit. The insert may include a filter material for positioning within the drinking conduit and an encapsulated flavor delivery system accompanying the filter material.

### RELATED APPLICATIONS

The present application claims priority of U.S. Provisional Application Serial No. 60/375,581, filed on Apr. 25, 2002.

### TECHNICAL FIELD

The present invention relates to an insert for a straw and more particularly relates to methods and apparatuses for coating an insert with flavoring and positioning the insert within a straw so as to flavor a beverage.

### BACKGROUND OF THE INVENTION

Various types of “flavored” drinking straws are known. By the term “flavored”, we mean that an additional substance of some nature has been placed within the straw such that the substance comes into contact with the beverage as the drinker draws the beverage through the straw. Most of these known devices generally require that the straw itself be manufactured so as to accommodate the addition of the flavoring via an additional structure or a coating technique of some sort. These additional manufacturing steps, however, may be detrimental in terms of the speed of manufacture and/or the cost of the materials. Further, known flavored straws generally only flavor the first several sips of a beverage as the beverage is drawn through the straw. The flavoring may then dissipate quickly upon further contact with the beverage.

What may be desired, therefore, are methods and apparatuses for providing flavoring to a straw. Preferably, the methods and the apparatuses should not materially increase the time of manufacture, increase the cost of manufacture, or decrease the production capacity with respect to the straw. Further, the flavoring should last for the anticipated volume of the beverage.

### SUMMARY OF THE INVENTION

The present invention thus provides an insert for use with a drinking conduit. The insert may include a filter material for positioning within the drinking conduit and an encapsulated flavor delivery system accompanying the filter material.

The filter material may be in the form of a hollow cylinder. The filter material may include a paper. The filter material may include a hydrophilic filter paper with a mass of about 85 grams per meter squared.

The encapsulated flavor delivery system may be absorbed within the filter material or coated onto the filter material. The encapsulated flavor delivery system may include a fruit flavor, a coloring agent, a source of carbonation, a nutrient, a product additive, a preservative, or a combination thereof. The encapsulated flavor delivery system may include a flavoring encapsulated in a matrix material. The encapsulated flavoring may include an oil, an alcohol, an aldehyde, an organic acid, an ester, a lactone, a ketone, or a combination thereof. The encapsulated flavor delivery system may include an emulsifier and a carrier material. The encapsulated flavor delivery system may be dissolved within a bath of water and a solvent. The encapsulated flavor delivery system further may include a nonencapsulated flavoring.

A further embodiment of the present invention may provide for an insert for use within a drinking straw. The insert may include a filter cylinder positioned within the drinking straw. The filter cylinder may include a hollow passageway and an encapsulated delivery system absorbed therein. The encapsulated delivery system may include a flavoring. The filter cylinder may include an interior diameter of about eighty-five (85) to about ninety-nine (99) percent of an interior diameter of the drinking straw.

A method of the present invention may provide for applying a flavor delivery system to an insert for use with a drinking conduit. The method may include adding the flavor delivery system to a bath of water and a solvent, passing the insert through the bath such that the flavor delivery system is absorbed within the insert, drying the insert such that the flavor delivery system remains substantially intact on the insert, and positioning the insert within the drinking conduit. The method further may include passing a beverage through the drinking conduit such that the insert comes into contact with the beverage and the flavor delivery system cause the beverage to change flavor.

A further embodiment of the present invention may provide for an apparatus for manufacturing and positioning a flavored insert within a drinking straw. The apparatus may include a continuous strip of insert paper positioned along a predetermined path, a bath positioned along the predetermined path, the bath may include a flavor delivery system dissolved therein so as to soak the continuous strip, a cutting device positioned along the predetermined path so as to cut a sheet from the continuous strip, a rolling device positioned along the predetermined path so as to roll the sheet into the form of the insert, and an insertion device positioned along the predetermined path so as to position the insert within the drinking straw. The apparatus further may include a dryer positioned along the predetermined path so as to dry the continuous strip with the flavor delivery system soaked therein and a crimping device positioned along the predetermined path so as to crimp the drinking straw so as to position the insert therein.

Other features of the invention will become apparent upon review of the following detailed description of the invention when taken into consideration with the drawings and appended claims.

### BRIEF DESCRIPTION OF THE DRAWINGS

FIG. 1 is a perspective view of a straw of the present invention with an insert shown in phantom lines.

FIG. 2 is a side cross-sectional view of the insert within the straw of FIG. 1 taken along line 2-2.

FIG. 3 is a schematic view of a straw insert device of the present invention.

### DETAILED DESCRIPTION

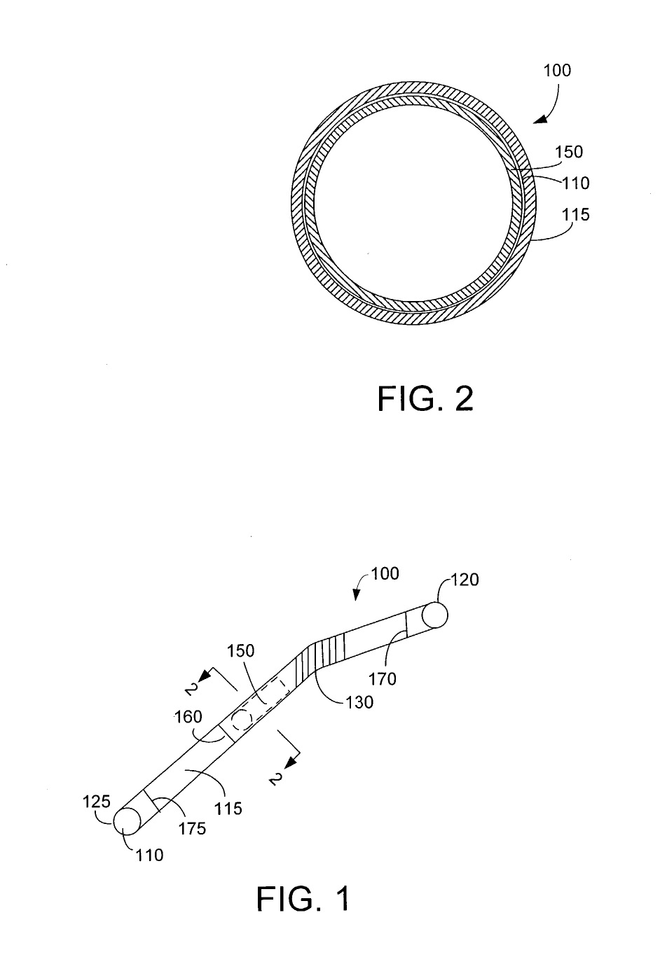

Referring now to the drawing, in which like numerals refer to like elements throughout the several views, FIGS. 1 and 2 show a straw 100 for use with the present invention. The straw 100 may be of conventional design. In addition to the straw 100, the present invention also may be applicable to other types of beverage delivery systems, such as bottlenecks, baby bottle nipples, and similar types of conduits and/or other types of devices through which a fluid may pass. The term “straw” is used herein to describe any such device.

The straw 100 may be made out of a polymer such as polypropylene or similar types of materials. The straw 100 may be formed in an extrusion process or any other conventional manufacturing process. The straw may have an inner surface 110 and an outer surface 115. The straw 100 may have an inside diameter of about five (5) to about ten (10) millimeters. The straw 100 may have a length of about twenty-one (21) centimeters. The dimensions of the straw 100 given herein are used for the purpose of example only. The straw 100 may have any desired dimension or shape. The straw 100 may have a first end 120 and a second end 125. The straw 100 may have a bending zone 130 positioned towards one of the ends 120, 125. The bending zone 130 may be formed from a series of crimps therein so as to allow the straw 100 to be bent.

An insert 150 may be placed within the inner surface 110 of the straw 100. The insert 150 may be made out of paper or similar types of absorbent materials. The insert 150 preferably is a hydrophilic filter paper with good absorption characteristics. The insert 150 preferably is made out of food grade paper or other types of food grade materials. The insert 150 preferably also has a high wet strength so as to maintain its integrity during use. The insert 150 may be a filter paper sold by Schleicher & Schuell GmbH of Dassel, Germany and Schleicher & Schuell, Inc. of Keane, N.H. under the indicator “5N7nf”. Such a filter paper may have a mass of about 85 grams per meter squared. Similar types of filter papers may be used as the insert 150. Further, other types of absorbent materials and/or combinations of absorbent media also may be used herein. The straw 100 and the insert 150 as shown in FIGS. 1 and 2 are not necessarily proportional.

In this example, the paper of the insert 150 may have a thickness of about 0.05 to about 0.20 millimeters. The insert 150 may be in the shape of a square with an edge length of about 55 millimeters or in the shape of a circle with a diameter of about 55 millimeters. The paper may be rolled to form a cylinder with an outside diameter to match the inside diameter of the inner surface 110 of the straw 100 and an inside diameter of about 0.15 to about 0.6 millimeters less that the inner diameter of the inner surface 110. The insert 150 thus leaves about eighty-five (85) to ninety-nine (99) percent of the interior diameter of the straw 100 unobstructed for the passage of the beverage.

A flavoring delivery system may be coated on to and/or absorbed within the insert 150. The flavoring delivery system may include a liquid flavoring or a flavoring encapsulated in a matrix material. The encapsulated flavoring may include oils, alcohols, aldehydes, organic acids, esters, lactones, ketones, similar compounds, or combinations thereof. The flavoring itself may include any known flavor. For example, fruit flavors may be used for the modification of the taste of a carbonated soft drink, such as orange, lemon, lemon-lime, grapefruit, passion fruit, mango, raspberry, strawberry, black currant, and cherry. Other suitable flavors may include peppermint and similar flavors. Blends of two or more flavors may be used. The flavoring may be an individual compound or a complex flavor. The flavoring also may include a coloring agent, a source of carbonation, any type of nutrient, any type of product additive, a preservative, or any other type of fluid or combination thereof.

To encapsulate the flavoring, the liquid flavoring may be emulsified into an aqueous solution of an emulsifier and a carrier material. Carrier materials may include maltodextrin, sucrose, or similar materials. Suitable emulsifiers may be modified starch, gum arabic, or similar materials. This emulsion then may be spray dried so as to provide the flavoring delivery system used herein in the form of a powder of flavor droplets finely dispersed within a solid matrix of the carrier material. Alternatively, the flavor may be sprayed into a carrier in a fluid bed dryer. Flavoring delivery systems useful with the present invention may be sold by Givaudan Roure SA of Vernier, Switzerland under the trademarks Granuseal®, Permaseal®, Ultraseal®, and Flavourburst®. Patents owned by Givaudan include, but are not limited to, U.S. Pat. Nos. 6,325,859; 6,056,949; 6,106,875; 6,045,835; and 5,759,599. These patents are incorporated herein by reference.

The flavoring delivery system may be applied to the insert 150 by dissolving the flavoring delivery system powder within a bath of water and a solvent. The solvent may be an ethanol or a similar type of water miscible highly volatile solvent. Once dissolved, the flavoring delivery system can absorb into and coat the paper of the insert 150. The insert 150, with the flavoring delivery system absorbed and/or coated thereon, then may be dried. The drying may be done at room temperature or at elevated temperatures of up to about one hundred degrees (100 ) Celsius. A drying tunnel also may be used.

Once dried, the flavor of the flavoring delivery system generally will keep its integrity and will stay substantially intact within and on the insert 150. A certain separation of the flavoring from the matrix material may occur as the aqueous matrix material solution is drawn inside the hydrophilic paper of the insert 150. Drying time may be several minutes if an oven is used to several hours if the insert 150 is left to dry at room temperatures. The addition of an ethanol or a similar type of solvent should accelerate the drying process.

Other options for loading the flavoring delivery system onto the insert 150 are possible. For example, a solvent may wet the surface of the insert 150 and a fine dust of the powered flavoring delivery system may be sprayed thereon. The solvent should make the powdered flavoring delivery system stick to the paper of the insert 150. Alternatively, the paper may be soaked in the emulsion of the liquid flavoring before the spraying and drying steps as described above. The filter paper with the flavoring delivery system thereon may then be dried together.

A non-encapsulated liquid flavoring also may be used herein. The non-encapsulated liquid flavoring, however, may substantially dissipate during the drying process. As such, additional flavoring may be needed. Combinations of encapsulated and non-encapsulated liquids may be used.

Once the insert 150 is dried, the insert 150 may be rolled into the shape of a cylinder and inserted within the straw 100. Once in place, the insert 150 may expand against the inner surface 110 of the straw 100. This expansion may aid in keeping the insert 150 in the proper position. The insert 150 may be positioned just underneath the bending zone 130. The bending zone 130 may maintain the insert 150 in position. An insert crimp 160 may be added to the straw 100 just below the position of the insert 150 such that the insert 150 stays between the crimp 160 and the bending zone 130. A further crimp may be positioned between the insert 150 and the bending zone 130. For example, a first crimp 170 may be added to the first end 120 and a second crimp 175 also may be added to the second end 125 of the straw 100 to ensure that the insert 150 remains within the straw 100 at all times. Other types of positioning means may be used. Different types of adhesive techniques also may be used.

As described above, the insert 150 may have an inside diameter to provide a sufficient clearance such that a user can suck the beverage through the straw 100 without undue effort. A sufficient amount of the flavoring delivery system should be added to the insert 150 such that a typical beverage may be flavored at a consistent level. As is described below, the amount of the flavoring delivery system used will vary with the anticipated volume of the beverage and/or the nature of the flavoring and other materials.

### EXAMPLE 1

Six (6) grams of raspberry Permaseal sold by Givaudan under the indicator “10721-31” were dissolved in ten (10) grams of dionized water. A filtered paper circle sold by Schleicher & Schuell under the indicator “LS14” having a diameter of about 55 millimeters was soaked for about three (3) seconds in the solution and then dried over night at room temperature. The dried filter paper was rolled up to form the insert 150. The insert 150 was then placed within the straw 100 just behind the bending zone 130. The user then drank a beverage, in this case a 0.4 liter “Sprite” carbonated soft drink sold by The Coca-Cola Company of Atlanta, Ga., through the straw 100. The taste of the beverage changed noticeably from lemon-lime to raspberry.

### EXAMPLE 2

Seven (7) grams of cherry Granuseal sold by Givaudan under the indicator “60343-DO” were dissolved in seven (7) grams of dionized water. Three (3) grams of ethanol were added to the solution. A filter paper square sold Schleicher & Schuell under the indicator “597nf” having an edge length of about 55 millimeters was soaked for about three (3) seconds and then dried in an air convection oven at about seventy degrees (70°) Celsius for about ten (10) minutes. The dried filter paper was then rolled to form a hollow cylinder with an outer diameter of about five (5) millimeters and inserted into the straw 100 just below the bending zone 130. The user then drank a beverage, in this case a 0.4 liter “Sprite” carbonated soft drink sold by The Coca-Cola Company of Atlanta, Ga., through the straw 100. The taste of the beverage changed noticeably from lemon-lime to cherry.

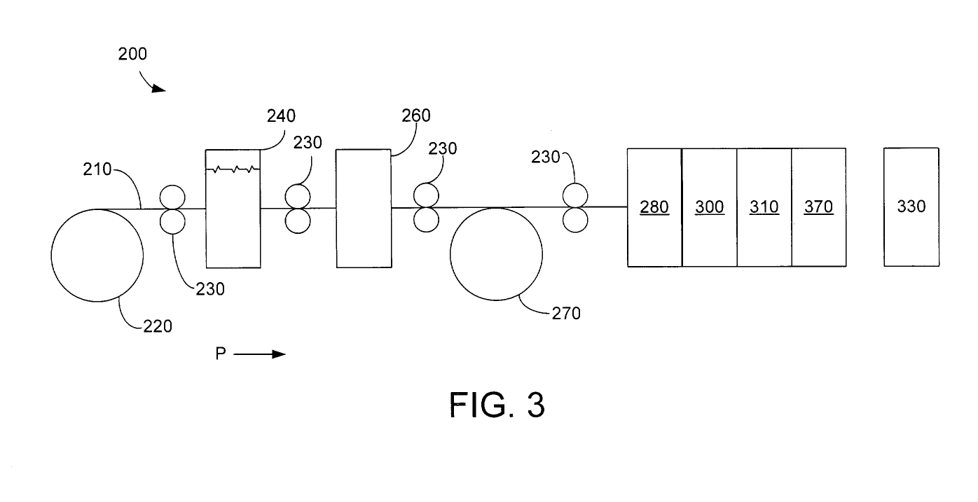

FIG. 3 shows one possible embodiment of a straw insert device 200 of the present invention. The straw insert device 200 may include a number of stations as described in more detail below. The nature, number, and positioning of these stations may be substantially altered. Certain stations may be eliminated entirely. Some or each of the functions described herein also may be performed by hand. The stations of the straw insert device 200 may proceed along a predetermined path P.

The filter paper used for the insert 150 may take the form of a continuous strip 210 loaded onto a spool 220 or a similar type of device. The continuous strip 210 may be advanced throughout the straw insert device 200 via a series of rollers 230. The rollers 230 may be powered by conventional means. Positioned adjacent to the spool 220 may be a flavoring bath 240. The flavoring bath 240 may include a flavoring delivery system 250 as described above within a solution of water and a solvent such as ethanol. The continuous strip 210 may travel through the flavoring bath 240 for about three (3) seconds or more such that the flavoring delivery system 250 may be substantially absorbed within the continuous strip 210. The amount of time in the flavoring bath 240 may vary depending upon the nature of the continuous strip 210, the nature of the flavoring delivery system 250, and other variables such as temperature and pressure.

Positioned adjacent to the flavoring bath 240 may be a dryer 260. The dryer 260 may be an air convection oven as described above. Conduction or microwave heating also may be used. Alternatively, the continuous strip 210 may be left to dry at room temperature.

Positioned adjacent to the dryer 260 may be a second spool 270 or a similar type of device. The dried continuous strip 210 may be stored on the second spool 270 until needed.

Positioned adjacent to the second spool 270 or the dryer 260 may be a cutting device 280. The cutting device 280 may be positioned directly adjacent to the dryer 260 if the second spool 270 is not used. The cutting device 280 may include any type of cutting device such as a cutting blade or a cutting wheel. Thermal, optical, or other types of cutting devices also may be used. The cutting device 280 cuts a sheet 290 of the filter paper from the continuous strip 210. The filter paper is cut such that the sheet 290 may form the Insert 150 in the desired length and/or diameter.

Positioned adjacent to the cutting device 280 may be a rolling device 300. The rolling device 300 may wrap the sheet 290 around a central spindle or a similar type of device so as to form the insert 150 into the shape of a cylinder with a predetermined inside and outside diameter. Alternatively, the rolling device 300 also may use any conventional type of paper roller to form the desired cylinder shape.

Positioned adjacent to the rolling device 300 may be an insert device 310. The insert device 310 may have a supply of straws 100 positioned therein or adjacent thereto. The insert device 310 may position the insert 150 within the straw 100 just below the bending zone 130. The insert 150 may be positioned anywhere along the length of the straw 100. The insert device 310 may use a piston or a similar type of structure to position the insert 150 within the straw 100. Alternatively, any other type of insertion means may be used to position the insert 150 within the straw 100.

Positioned adjacent to the insert device 310 may be a crimping device 320. The crimping device 320 may provide the insert crimp 160 below the insert 150, the first and second crimps 170, 175 on the first and second ends 120, 125 of the straw 100, or otherwise along the length of the straw 100. The crimping device 320 may include a thermal or a mechanical crimper. Alternatively, the crimping device 320 also may use any other known crimping method. Further, some or all of the crimps 160, 170, 175 already may be present in the straw 100.

Positioned adjacent to the crimping device 320 may be a storage bin 330. The storage bin 330 may store the straws 100 until the straws 100 are shipped to the end user or the consumer. The straws 100 need not be individually packaged. The straws 100 need not be sealed in an airtight manner. Alternatively, the straws 100 may be individually packaged. Such packaging methods are known in the industry.

In use, the continuous strip 210 of the filter paper is pulled off of the spool 220 via the rollers 230. The continuous strip 210 passes through the flavoring bath 240 where the continuous strip 210 is soaked in the flavoring delivery system 250. The continuous strip 210 then passes through the dryer 260 such that the continuous strip 210 is substantially dried. The continuous strip 210 may then be stored on the second spool 270 or may proceed to the cutting device 280. The cutting device 280 cuts a sheet 290 from the continuous strip 210 of filter paper. The sheet 290 then passes into the rolling device 300 where the sheet 290 is rolled into the form of the insert 150. The insert device 310 then places the insert 150 within the straw 100. Once the insert 150 is in position, the filter paper may expand somewhat such that the insert 150 maintains its position within the straw 100 just below the bending zone 130. Crimps 160, 170, and 175 also may be added to the straw 100 by the crimping device 320 so as to insure that the insert 150 maintains its position. The straws 100 may then be sent to the storage bin 330 until they are shipped to the consumer and/or the end user.

The consumer then draws a beverage through the straw 100 with the insert 150 therein. As described above, the insert comes into contact with the beverage and causes the beverage to change flavor. The nature of the flavor may be advertised or printed on the straw 100 or its packaging. Alternatively, straws 100 of different flavors may be available such that the consumer does not know which flavor he or she may have until the beverage is consumed with the straw 100. The invention thus provides a means to offer additional flavors to the consumer without impacting the taste, color, or appearance of the original beverage.

It should be apparent that the foregoing relates only to the preferred embodiments of the present invention and that numerous changes and modifications may be made herein without departing from the spirit and scope of the invention as defined by the following claims and the equivalents thereof.

I claim:

1. An insert for use with a drinking conduit, comprising:
a filter material for positioning within the drinking conduit; and
an encapsulated flavor delivery system accompanying said filter material.

2. The insert of claim 1, wherein said filter material comprises a hollow cylinder.

3. The insert of claim 1, wherein said filter material comprises a paper.

4. The insert of claim 1, wherein said filter material comprises a hydrophilic filter paper, said hydrophilic filter paper comprising a mass of about 85 grams per meter squared.

5. The insert of claim 1, wherein said encapsulated flavor delivery system is absorbed within said filter material.

6. The insert of claim 1, wherein said encapsulated flavor delivery system is coated onto said filter material.

7. The insert of claim 1, wherein said encapsulated flavor delivery system comprises a fruit flavor, a coloring agent, a source of carbonation, a nutrient, a product additive, a preservative, or a combination thereof.

8. The insert of claim 1, wherein said encapsulated flavor delivery system comprises a flavoring encapsulated in a matrix material.

9. The insert of claim 8, wherein said encapsulated flavoring comprises an oil, an alcohol, an aldehyde, an organic acid, an ester, a lactone, a ketone, or a combination thereof.

10. The insert of claim 1, wherein said encapsulated flavor delivery system comprises an emulsifier.

11. The insert of claim 1, wherein said encapsulated flavor delivery system comprises a carrier material.

12. The insert of claim 1, wherein said encapsulated flavor delivery system is dissolved within a bath of water and a solvent.

13. The insert of claim 1, wherein said encapsulated flavor delivery system further comprises a nonencapsulated flavoring.

14. An insert for use within a drinking straw, comprising:
a filter cylinder positioned within the drinking straw;
said filter cylinder comprising a hollow passageway; and
an encapsulated delivery system absorbed within said filter cylinder;
said encapsulated delivery system comprising a flavoring.

15. The insert of claim 14, wherein said filter cylinder comprises an interior diameter of about eighty-five (85) to about ninety-nine (99) percent of an interior diameter of the drinking straw.

16. A method for applying a flavor delivery system to an insert for use with a drinking conduit, comprising:
adding the flavor delivery system to a bath of water and a solvent;
passing the insert through the bath such that the flavor delivery system is absorbed within the insert;
drying the insert such that the flavor delivery system remains substantially intact on the insert; and
positioning the insert within the drinking conduit.

17. The method of claim 16, further comprising passing a beverage through the drinking conduit such that the insert comes into contact with the beverage and the flavor delivery system cause the beverage to change flavor.

18. An apparatus for manufacturing and positioning a flavored insert within a drinking straw, comprising:
a continuous strip of insert paper positioned along a predetermined path;
a bath positioned along said predetermined path;
said bath comprising a flavor delivery system dissolved therein so as to soak said continuous strip;
a cutting device positioned along said predetermined path so as to cut a sheet from said continuous strip;
a rolling device positioned along said predetermined path so as to roll said sheet into the form of the insert; and
an insertion device positioned along said predetermined path so as to position the insert within the straw.

19. The apparatus of claim 18, further comprising a dryer positioned along said predetermined path so as to dry said continuous strip with said flavor delivery system soaked therein.

20. The apparatus of claim 18, further comprising a crimping device positioned along said predetermined path so as to crimp the drinking straw so as to position the insert therein.
